(19) United States
(12) Patent Application Publication
(10) Pub. No.: US 2002/0156220 A1
(43) Pub. Date: Oct. 24, 2002

(54) High solids acrylic resin

(76) Inventors: Gerald Wayne Meyer, Crystal Lake, IL (US); Jean Elizabeth Marie Fletcher, Crystal Lake, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/789,127

(22) Filed: Feb. 20, 2001

(51) Int. Cl. C08F 118/02

(52) U.S. Cl. 526/319

(57) ABSTRACT

This invention is directed to acrylic copolymers which have ester linkages which are part of a repeating side groups which extend from the longitudinal polymer chain. The acrylic copolymers of the invention are effective for providing polymeric vehicles and formulated coating compositions for coating binders that are high in solids and have reduced levels of volatile organic solvents or volatile organic compounds.

The present invention relates to a high solids acrylic resin composition. More particularly, this invention is directed to polymeric vehicles and formulated coating compositions for coating binders that are high in solids and have reduced levels of volatile organic compounds. The polymeric vehicles of the invention include acrylic copolymers formed through the reaction of acrylic monomers having active hydrogen functionality and α, β unsaturated olefinic esters. The polymeric vehicles of the invention provide a topcoat with properties such as high gloss retention, solvent and humidity resistance, and sufficient hardness and adhesion to be useful in various marine, maintenance and industrial applications.

### BACKGROUND

Marine coatings and other industrial type coatings require certain performance criteria in order for those coatings to be appropriate for those uses. Performance criteria which are often important in these types of applications may include gloss retention, solvent resistance, humidity resistance, salt spray resistance, hardness and adhesion. A coating must provide these types of performance criteria while balancing the need to provide a coating with low amounts of volatile organic compounds (VOCs) or organic solvents and an acceptable viscosity.

The use of high solids polymeric vehicles is one approach that has been used to reduce VOCs in coating compositions. High solids, low volatile organic compound containing compositions have become increasingly more important in the coatings industry in part due to government regulations limiting the emissions from those coatings. Further, environmental concern over the use of organic solvents has become increasingly important to the coating industry. This concern not only extends to preservation of the environment for its own sake, but extends to public safety as to both living and working conditions. Volatile organic emissions resulting from coating compositions which are applied and used by industry and by the consuming public are not only often unpleasant, but also contribute to photochemical smog. Governments have established regulations setting forth guidelines relating to volatile organic compounds (VOCs) which may be released to the atmosphere. The U.S. Environmental Protection Agency (EPA) established guidelines limiting the amount of VOCs released to the atmosphere, such guidelines being scheduled for adoption or having been adopted by various states of the United States. Guidelines relating to VOCs, such as those of the EPA, and environmental concerns are particularly pertinent to the paint and coating industry which uses organic solvents that are emitted into the atmosphere.

Typical high solids systems limit the molecular weights of the polymers used in the polymeric vehicle, which limits the impact resistance and other properties of the coating binders and films resulting from the polymeric vehicles. Thermosetting, high solids systems generally obtain higher molecular weight through crosslinking, rather than being obtained from the basic polymer structure. Hence, high solids systems normally supply a large number of reactive sites available for crosslinking such that the resulting compositions have adequate properties. The high functionality tends to increase viscosity and leads to the use of higher levels of organic solvents in order to obtain acceptable viscosities.

U.S. Pat. Nos. 4,818,796 and 4,988,766 describe low molecular weight hydroxyl-containing polymers prepared by reaction of a polymerizable alpha, beta-ethylenically unsaturated carboxylic acid and an epoxy compound. The polymer of the '796 patent must have a hydroxyl number of at least 130 and a weight average molecular weight of less than 15,000 such that the polymer is curable with a curing agent to provide desired properties. The hydroxyl containing polymer of the '796 patent is prepared by heating an polymerizable alpha, beta-ethylenically unsaturated carboxylic acid and an epoxy compound in the presence of a free radical initiator. The resulting polymer contains an equivalent ratio of acid to epoxy of at least 1 to 1. It does not describe the α, β unsaturated monomers used to make the copolymers described herein nor does it describe the careful selection and balancing of a comonomer system to obtain the hydroxyl value, polydispersity index and molecular weight which provides the desired properties of the cured coating binder which results from curing the acrylic copolymers of the invention.

### SUMMARY

The invention is directed to acrylic copolymers which have ester linkages which are a part of repeating side groups which extend from the longitudinal polymer chain. The monomer mix to make these acrylic copolymers of the invention and the low hydroxyl value of these acrylic copolymers provide these acrylics of the invention with desirable properties, such as gloss retention, low viscosity, a T_{g} of about −10° C. to about 60° C., and in an important aspect, about 30° C. to about 5° C., and a hardness of at least about 2B after curing. The lower hydroxyl values of the acrylic copolymers require lower amounts of cross-linker such as isocyanate crosslinkers, yet still permit the modified acrylic polymers of the invention to provide an isocyanate cured coating binder with a pencil hardness of at least about 2B and gloss retention of at least about 50% after 1,000 hours of ultra violet light exposure using ASTM test D4587, method B. The use of (a) acrylic monomers having active hydrogen functionality, (b) α, β unsaturated monomers which include a large ester side group or appendage (as hereinafter defined) and (c) other selected unsaturated monomers provide a high solids modified acrylic polymer with a low viscosity, low VOCs and desirable properties in a resulting cured binder film made with the modified acrylic polymers of the invention.

The acrylic polymers of the invention are a free radically polymerized blend of (1) acrylic monomers having an active hydrogen functionality, (2) monomers having α, β double bonds which unsaturated monomers do not have active hydrogen functionality (non-active hydrogen comonomer) and (3) α, β unsaturated monomers which include a large ester side group (hereinafter “ester side group monomer”). When incorporated into the polymer of the invention, the active hydrogen functionality on the acrylic monomers will be reactive with cross-linkers such as isocyanate. The acrylic monomers having active hydrogen functionality and other unsaturated monomers are free radically polymerized with each other through their respective double bonds. The ratio of acrylic monomer having active hydrogens, monomers having hydroxyl groups, and other monomers is effective to provide an acrylic copolymer with a hydroxyl value of at least about 40, but not more than about 135, and in an important aspect, a hydroxyl value in the range of from about 40 to about 80. The free radical polymerization conditions, free radical initiator and reaction solvent are selected to provide an acrylic copolymer with a number average molecular weight of not more than about 5,000, at least about 500, and in one aspect, from about 1,000 to about 3,000 and a polydispersity index (PDI) of not more than about 3, and in one aspect, from about 2.0 to about 2.4. The low hydroxyl value of the acrylic copolymers of the invention permits the use of lower amounts of crosslinker, such as a multifunctional isocyanate, to achieve hardness of at least about 2B using not more than about 22 weight percent hexamethylenediisocyanate (HDI) cross linker, based upon the weight of acrylic copolymer. The higher molecular weight, coupled with low PDI of the acrylic copolymers of the invention, helps to provide the acrylic copolymers of the invention with a low viscosity which reduces the need for solvent, and also reduces undesirable VOCs.

The “active hydrogen” functionality of the acrylic monomer is carboxyl (—COOH), hydroxyl (—OH) and amine (—NHR, where R═H or a lower alkyl group with one to 4 carbon atoms), and in a very important aspect is hydroxyl. The active hydrogen functionality, such as the hydroxyl active hydrogen functionality on the acrylic monomers is reactive with cross linkers such as isocyanates and aminoplasts.

Generally, the ester side group monomer will be from about 15 to about 40 weight percent of the weight of reactants 1 through 3 used to make the acrylic copolymer.

The α, β ethylenically unsaturated monomers which do not have an active hydrogen functionality (and which are not the ester side group monomers) include styrene, vinyl acetate (VA), alpha-methylstyrene, vinyl toluene, and acrylic or methacrylic esters, such as methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate and n-octyl (meth)acrylate, allyl methacrylate, methyl methacrylate (MMA), butyl acrylate (BA), butyl methacrylate (BMA), ethyl acrylate (EA), and lauryl methacrylate.

The non-active hydrogen comonomer should not be in excess of about 80 weight percent, based on the total weights of the acrylic monomer with active hydrogen functionality, ester side group monomer and non-active hydrogen comonomer.

The acrylic copolymers of the invention have a solids content of at least about 70 weight percent, preferably about 80 weight percent and a viscosity of not more than about 6,800 cps at 25° C. at 80 weight percent solids and not more than 20 weight percent organic solvent. The acrylic copolymers of the invention are effective for providing polymeric vehicles with such solids content and viscosities and formulated coating compositions with VOC levels of less than about 250 grams per liter.

The modified acrylic polymers and polymeric vehicles of the invention are effective for providing coating binders having a high gloss retention, at least 50% after 1,000 hours of UV light exposure under ASTM test D4587 method B, a hardness of at least about 2B, and an adhesion of at least about 4B over cold rolled steel.

Generally, the ester side group monomer modifying monoglycidyl reactant comprises from about 15 to about 40 weight percent of monomers 1 through 3 used to make the acrylic copolymer. The ester side group monomer generally is an α, β unsaturated monomer with an aliphatic portion having one or more ester groups. In one aspect, the aliphatic portion has a molecular weight in the range of from about 130 to about 500. Particularly useful ester side group monomers used in the invention have the general formula

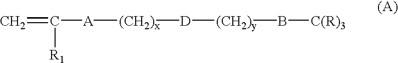

where A═

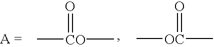

or bond, D and B are each selected from the group consisting of

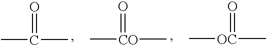

or bond, R

represents hydrogen or the same or a mixture of aliphatic groups having from about 1 to about 26 carbon atoms which may include one or more ester linkages, x is from 0 to 20, y=0 to 20 and R₁ is a C₁ to C₄ (one to four carbon atoms) alkyl group.

In another aspect R₁═H, A=bond, x=0, D=bond, y=0, B=

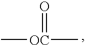

one R is Me and the other Rs total 6 or 7 carbon atoms. In one case the monomer is

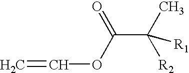

where R₁+R₂=alkyls having a total of 6 carbon atoms, which is available as VeoVa 9 vinyl ester from Resolution Performance Products, and in another aspect, the monomer is

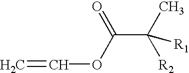

where R₁+R₂=alkyls having a total of 7 carbon atoms, which is available as VeoVa 10 from Resolution Performance Products.

### DETAILED DESCRIPTION

Definitions

“Polymeric vehicle” means all polymeric and resinous components in the formulated coating, i.e., before film formation. The polymeric vehicle may include a cross-linking agent.

“Coating binder” means the polymeric part of the film of the coating after solvent has evaporated and after any potential crosslinking has occurred.

“Formulated coating” means the polymeric vehicle and solvents, pigments, catalysts and additives which may optionally be added to impart desirable application characteristics to the formulated coating and desirable properties such as opacity and color to the film.

“Cross-linker” means a di- or polyfunctional substance, such as an isocyanate, blocked isocyanates, prepolymerized isocyanates, and aminoplasts all of which have functional groups which are capable of forming covalent bonds with the acrylic polymer having active hydrogens such as through the hydroxyl functionality and carboxyl functionality.

“Solvent” means an organic solvent.

“Organic solvent” means a liquid which includes but is not limited to carbon and hydrogen where the liquid has a boiling point in the range of not more than about 280° C. at about one atmosphere pressure.

“Active hydrogen functionality” means carboxyl, hydroxyl and/or amine functionality which is reactive with isocyanate and/or aminoplast functionality.

As used herein “acrylic monomer” means a monomer such as

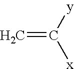

wherein

y=methyl, ethyl, propyl, butyl or H

x=—COOR₁ or —NR₂R₃ where R₁═H or lower alkyl, R₂═H or lower alkyl, R₃=H or lower alkyl, but at least one of R₂ or R₃ is H.

Acrylic monomer with active hydrogen functionality means an acrylic monomer as defined herein which also includes active hydrogens if it already does not have them by virtue of x being an active hydrogen functional group.

The modified acrylic polymers of the invention are a free radically polymerized blend of (1) acrylic comonomers having an active hydrogen functionality. (2) non-active hydrogen comonomer, and (3) ester side group comonomer. The free radical polymerization conditions for comonomers 1 through 3 and the ratio of these comonomers are effective for providing an acrylic copolymer with a hydroxyl value of from about 40 to less than about 135, a T_{g} of from about −10° C. to about 60° C., and in an important aspect about 30° C. to about 5° C., a number average molecular weight of not more than about 5,000, at least about 500, and in one aspect, from about 1,000 to about 3,000 and a polydispersity index (PDI) of not more than about 3, and in one aspect, from about 2.0 to about 2.4. The acrylic monomer having active hydrogen functionality generally will comprise from about 1 to about 20 weight percent of comonomers 1 through 3, the non active hydrogen comonomer will comprise from about 40 to about 80 weight percent of comonomers 1 through 3, and the ester side group comonomer will comprise from about 15 to about 40 weight percent of comonomers 1 through 3. In an important aspect, hydroxyl groups are particularly useful for the active hydrogens on the acrylic monomer which functionality will react with isocyanate cross linkers.

The polymerization organic solvent which will generally have a boiling point in the range of from about 150° C. to about 270° C., initiator and the polymerization reaction temperature are all carefully selected to provide the molecular weight range and PDI for the modified acrylic polymers of the invention. Solvents such as ethyl 3-ethoxypropionate (EEP), hexyl acetate, heptyl acetate, glycol ethers such as propylene glycol mono ethyl ether acetate and isobutyl isobutryate may be used. Free radical initiators such as di-t-amyl peroxide (DTAP) and di-tertiary butyl peroxide may be used. To control PDI and molecular weight, higher reaction temperatures in the range of from about 120° C. to about 200° C. help keep PDI desirably low.

In another aspect the acrylic copolymer of the invention has repeating units along its longitudinal backbone which has the general formula

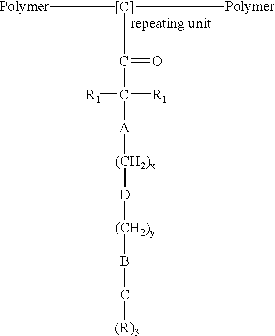

wherein the polymer has a hydroxyl value of from about 40 to less than about 135, a T_{g} of from about −10° C. to about 60° C., and in an important aspect about 30° C. to about 5° C., a number average molecular weight of not more than about 5,000 and at least about 500, and in one aspect, from about 1,000 to about 3,000 and a polydispersity index (PDI) of not more than about 3, and in one aspect, from about 2.0 to about 2.4. A, x, D, y, B, R₁ and R are defined above.

Reactions with Isocyanates

The active hydrogen functionality of the acrylic copolymers of the invention including the hydroxyl functionality of these acrylic polymers will be reactive with isocyanate. Useful isocyanates may include diisocyanates and polyisocyanates. Diisocyanates which may be used in the invention include hexamethylenediisocyanate(HDI) and isophorone diisocyanate (IPDI). The polyisocyanates may be dimerized or trimerized diisocyanates such as trimerized HDI or IPDI.

In another aspect of the invention, unblocked biurets such as the biuret of hexamethylene diisocyanate (HDI) which biuret has the structure

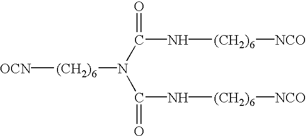

and is a trimerized product of hexamethylene diisocyanate and water may be used in lieu of polyisocyanates.

The following examples illustrate methods for carrying out the invention and should be understood to be illustrative of, but not limiting upon, the scope of the invention which is defined in the appended claims.

### EXAMPLES

### Example I

Modification Procedures and Resin Synthesis

i. Resin Preparation with AAEM Monomer

790.1 g of EEP is charged to a 3L 4-neck round bottom flask equipped with a thermocouple controlled heating mantle, an overhead stirrer, nitrogen sparge and a condenser. The reactor contents are heated to 162.8° C. (325° F.). All acrylic, styrene and ester side monomers in Table 1 are premixed along with 15.87 g EEP and 29.75 g DTAP in a separate container. Once the EEP solvent stabilized at approximately 163° C., the monomer/initiator mixture is pumped into the flask over a 6 hour period (approximately 3.45 g/min). After the addition is complete, the mix container is washed with 9.09 g EEP and added to the reactor. After 1 hour continued stirring at 163° C., Gardner viscosity, color, resin solids and acid value (ΔV) are recorded and an additional 2.98 g of DTAP is washed into the reactor with 4.54 g EEP. After 1 hour continued stirring at 163° C. Gardner viscosity, color, resin solids and AV are recorded and an additional 2.98 grams of DTAP is washed into the reactor with 2.00 g. EEP. One hour later, Gardner viscosity, color, resin solids and AV are again recorded. The resin is allowed to react for a total of 8 hours.

Following this reaction period, the reactor contents are cooled to 154° C. The reaction flask is modified to include a short-path vacuum distillation head with a thermometer in-line with the condenser and a receiver flask. Stirring is stopped and vacuum is slowly applied to avoid bumping and resin foaming. Full vacuum (28 inches of mercury) is eventually achieved. Stirring is resumed and distillation is allowed to proceed until temperature stabilized at 154° C. and essentially no further solvent is collected. A minimum of 97% resin solids is needed before distillation is halted.

The resin is allowed to cool to a minimum temperature of 140° C. at which point the n-butyl acetate is introduced into the reactor. The resin solution is allowed to cool to 110° C. Final resin solids (80+1.0%), viscosity, color and AV are recorded.

TABLE 1

| | % in Total | % Incorporated |
|---|---|---|
| Raw Material | Formulation | into Resin |
| Acetoacetoxyethyl | 13.8-16.9 | about 23.7- |
| Methacrylate (AAEM) | | about 29.0 |
| Methacrylic Acid | 0.2-0.4 | about 0.4- |
| | | about 0.7 |
| Hydroxyethyl | | about 7.4- |
| Methacrylate | 4.3-5.3 | about 9.1 |
| Butyl Acrylate | 12.2-15.0 | about 21.0- |
| | | about 25.7 |
| Styrene | 14.4-17.6 | about 24.7- |
| | | about 30.3 |
| Butyl Methacrylate | 6.0-7.4 | about 10.3- |
| | | about 12.7 |
| Methyl Methacrylate | 1.2-1.5 | about 2.1- |
| | | about 2.6 |
| Ethyl 3-Ethoxypropionate | 36.0-44.0 | |
| Di-t-Amyl Peroxide | 1.6-1.9 | |

ii. Resin Preparation with VeoVa9 Monomer

827.9 g of EEP is charged to a 3L 4-neck round bottom flask equipped with a thermocouple controlled heating mantle, an overhead stirrer, nitrogen sparge and a condenser. The reactor contents are heated to 162.8° C. (325° F.). All acrylic and ester side monomers in Table 2 are premixed along with 15.48 g EEP and 29.00 g DTAP in a separate container. Once the EEP solvent stabilized at approximately 163° C., the monomer/initiator mixture is pumped into the flask over a 6 hour period (approximately 3.57 g/min). After the addition is complete, the mix container is washed with 5.00 g EEP and added to the reactor. After 1 hour continued stirring at 163° C., Gardner viscosity, color, resin solids and acid value (AV) are recorded and an additional 2.90 g of DTAP is washed into the reactor with 4.44 g EEP. After 1 hour continued stirring at 163° C. Gardner viscosity and resin solids are recorded and an additional 2.90 grams of DTAP is washed into the reactor with 2.40 9. EEP. One hour later, Gardner viscosity and resin solids are again recorded, followed by the addition of 2.90 g DTAP and 2.20 g EEP. The viscosity and resin solids check followed by the initiator/solvent chaser is repeated two more times with an hour interval in between each chaser. The resin is allowed to react for a total of 12 hours.

Following this reaction period, the reactor contents are cooled to 154° C. The reaction flask is modified to include a short-path vacuum distillation head with a thermometer in-line with the condenser and a receiver flask. Stirring is stopped and vacuum is slowly applied to avoid bumping and resin foaming. Full vacuum (28 inches of mercury) is eventually achieved. Stirring is resumed and distillation is allowed to proceed until temperature stabilized at 154° C. and essentially no further solvent is collected. A minimum of 97% resin solids is needed before distillation is halted.

The resin is allowed to cool to a minimum temperature of 140° C. at which point the n-butyl acetate is introduced into the reactor. The resin solution is allowed to cool to 110° C. Final resin solids (80+1.0%), viscosity, color and AV are recorded.

TABLE 2

| | % in Total | % Incorporated |
|---|---|---|
| Raw Material | Formulation | into Resin |
| VeoVa 9 | 21.2-26.0 | about 33.6- |
| | | about 40.0 |
| Methacrylic Acid | 0.4-0.6 | about 0.7- |
| | | about 0.85 |
| Hydroxyethyl | 9.0-11.0 | about 14.3- |
| Methacrylate | | about 17.5 |
| Butyl Acrylate | 15.2-18.6 | about 24.0- |
| | | about 29.4 |
| Butyl Methacrylate | 7.8-9.6 | about 13.5- |
| | | about 16.5 |
| Methyl Methacrylate | 2.2-2.7 | about 3.8- |
| | | about 4.7 |
| Ethyl 3-Ethoxypropionate | 36.1-44.2 | |
| Di-t-Amyl Peroxide | 2.8-3.4 | |

2-Component Paint Formula

The paint formula used to screen and test the acrylic resins is found in the following:

Screening Paint Formula

| | |
|---|---|
| Raw Materials | Amount (g) |

Part A

| | |
|---|---|
| Resin | 100.0 |
| DisperBYK ® 110 | 7.21 |
| Ti-Pure ® R-902 | 367.5 |
| n-butyl acetate | 65.0 |

Grind to 7 Hegman

| | |
|---|---|
| Resin | 357.7 |
| T-12 Catalyst | 0.16 |
| Disparlon ® OX-70 | 7.8 |
| BYK ® 306 | 1.1 |
| n-butyl acetate | 17.0 |

Part B

| | |
|---|---|
| Desmodur ® N-3300 | 90.9 |

Paint Testing Procedures

The following Table lists the tests performed to evaluate each 2-component urethane paint and an ASTM reference where available.

| Test Performed | Method or ASTM Reference |
|---|---|
| Adhesion | D 3359 |
| Pencil Hardness | D 3363 |
| UV Resistance | D 4587 Method B |
| Salt Spray | B 117 |
| Humidity Resistance | D 4587 |
| Leveling | D 2801 |
| Sag | D 4400 |
| Viscosity | Stormer Viscometer- |
| | Part A only |
| Potlife | 2X Initial Viscosity- |
| | Brookfield |
| Chemical Resistance | 24 hr. Spot Test |
| Conical Mandrel Bend | D 522 |
| Dry Time | Circular Dry Time-D 5895 |

Paint Properties were as follows.

| | | 37% VeoVa 9, |
|---|---|---|
| | 25% VeoVa 9 | no styrene |
| Adhesion (CRS) | 4B | 0B |
| Pencil Hardness | HB | 2B |
| Mandrel Bend | No crack | No crack |
| Viscosity (Part A) | 83 | 76 |
| (KU) | | |
| Potlife (hrs) | 1.0 | 1.5 |
| Dry Time (hrs) | | |
| Set to Touch | 1.25 | 1.75 |
| Surface Dry | 3.0 | 4.0 |
| Through Dry | 4.5 | 4.75 |
| Print Free | >6.0 | >6.0 |
| Chemical Resistance^{a} | | |
| 0.1N Hcl | 5 | 5 |
| 0.1N NaOH | 5 | 5 |
| Xylene | 5 minutes | 5 minutes |
| Gasoline | 15 minutes | 15 minutes |
| Diesel Fuel | 4D, 4BL | 4D, 4BL |
| Axle Grease | 5 | 5 |
| Humidity (500 hrs) | 7D | 6D |
| Salt Spray (500 hrs) | | |
| Scribe Creep | 3 mm | 3 mm |
| Field Blisters | 4D | severe wrinkle |
| Wet Adhesion | 100% fail | 100% fail |
| QUV-A340 (60°/20°) | | |
| Initial | 93.5/87.2 | 91.4/84.5 |
| 152 hours | 87.3/57.0 | 75.7/43.7 |
| 483 hours | 80.6/46.7 | 68.5/33.1 |
| 1962 hours | 35.2/4.9 | 21.1/2.5 |
| QUV-B313 (60°/20°) | | |
| Initial | 93.5/87.2 | 91.4/84.5 |
| 167 hours | 82.8/47.7 | 73.2/40.7 |
| 503 hours | 53.8/11.4 | 32.5/4.7 |
| 2297 hours | 12.4/1.4 | 3.5/1.3 |

^{a}D = darkening, BL-blistering, (5 = best) , time is to failure

Numerous modifications and variations in practice of the invention are expected to occur to those skilled in the art upon consideration of the foregoing detailed description of the invention. Consequently, such modifications and variations are intended to be included within the scope of the following claims.

What is claimed is:

1. An acrylic copolymer which is the reaction product of reactants comprising:
at least one acrylic monomer having an active hydrogen functional group;
at least one α, β unsaturated monomer having which unsaturated monomer does not have active hydrogen functionality; and
at least one α, β unsaturated monomer which includes an ester side group, the ester side group being bonded to the α, β double bond of the monomer, the ester side group including an aliphatic group with one or more ester groups,
the acrylic monomer having the active hydrogen functionality, the monomer without active hydrogen functionality, and the ester side group monomer being polymerized through their double bonds to provide the acrylic copolymer, the acrylic copolymer having a hydroxyl number of not more than about 135, a polydispersity index of not more than about 3, and a Mn in the range of from about 500 to about 5,000.

2. The acrylic copolymer as recited in claim 1, wherein
the acrylic monomer having an active hydrogen functional group comprises from about 1 to about 20 weight percent;
the α, β unsaturated monomer having which unsaturated monomer does not have active hydrogen functionality comprises from about 40 to about 80 weight percent; and
the α, β unsaturated monomer which includes an ester side group comprises from about 15 to about 40 weight percent, the weight percents based upon the weights of the acrylic monomer having an active hydrogen functionality, the non-active hydrogen functional monomer, and ester side group monomer.

3. The acrylic copolymer as recited in claim 1 or 2 wherein the non-active hydrogen monomer is selected from the group consisting of styrene, vinyl acetate, alpha-methylstyrene, vinyl toluene, methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, n-octyl (meth)acrylate, allyl methacrylate, methyl methacrylate, butyl acrylate, butyl methacrylate, ethyl acrylate, lauryl methacrylate, and mixture thereof.

4. The acrylic copolymer as recited in claim 1 or 2, wherein the ester side group monomer has an aliphatic portion extending from the α, β double bond, which aliphatic portion includes ester groups, and wherein the aliphatic portion has a molecular weight in the range of from about 130 to about 500.

5. The acrylic copolymer as recited in claim 1 or 2, wherein the ester side group monomer having the formula 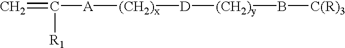
wherein A is 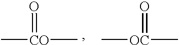
or bond, D and B are each selected from the group consisting of 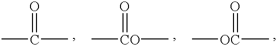
R₁ is a one to four carbon alkyl group, R is hydrogen or the same or a mixture of aliphatic groups having from about 1 to about 26 carbon atoms and which may include one or more ester linkages, x is from 0 to 20 and y is from 0 to 20.

6. The acrylic copolymer as recited in claim 5, wherein the active hydrogen functional group of the acrylic monomer having active hydrogen functionality is selected from the group consisting of carboxyl, hydroxyl and mixtures thereof.

7. The acrylic copolymer as recited in claim 6 wherein the acrylic copolymer has a solids content of at least about 80%, an organic solvent content of less than 20 weight percent and a viscosity of not more than about 6,800 cps at about 25° C.

8. An acrylic copolymer which is the reaction product of reactants comprising:
at least one acrylic monomer having an active hydrogen functional group selected from the group consisting of carboxyl, hydroxyl and mixtures thereof;
at least one α, β unsaturated monomer having which unsaturated monomer does not have active hydrogen functionality; and
at least one ester side group monomer which has the general formula, 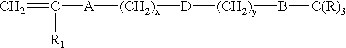
wherein A is 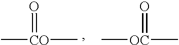
or bond, D and B are each selected from the group consisting of 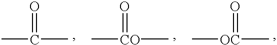
R₁ is a one to four carbon alkyl group, R is hydrogen or the same or a mixture of aliphatic groups having from about 1 to about 26 carbon atoms and which may include one or more ester linkages, x is from 0 to 20 and y is from 0 to 20, the acrylic monomer having the active hydrogen functionality, the monomer without active hydrogen functionality, the hydroxy functional unsaturated monomer, and the ester side group monomer being polymerized through their double bonds to provide the acrylic copolymer, the acrylic copolymer having a hydroxyl number of not more than about 135, a T_{g} of from about −10° C. to about 60° C., a polydispersity index of not more than about 3, a Mn in the range of from about 500 to about 5,000, a solids content of at least about 80%, an organic solvent content of less than 20 weight percent and a viscosity of not more than about 6,800 cps at about 25° C.

9. The acrylic copolymer as recited in claim 8, wherein
the acrylic monomer having an active hydrogen functional group comprises from about 1 to about 20 weight percent;
the α, β unsaturated monomer having which unsaturated monomer does not have active hydrogen functionality comprises from about 40 to about 80 weight percent; and
the α, β unsaturated monomer which includes an ester side group comprises from about 15 to about 40 weight percent, the weight percents based upon the weights of the acrylic monomer having an active hydrogen functionality, the non-active hydrogen functional monomer and the ester side group monomer.

10. The acrylic copolymer as recited in claim 8 or 9 wherein non-active hydrogen monomer is selected from the group consisting of styrene, vinyl acetate, alpha-methylstyrene, vinyl toluene, methyl (meth)acrylate, ethyl (meth)acrylate, isopropyl (meth)acrylate, n-butyl (meth)acrylate, isobutyl (meth)acrylate, n-amyl (meth)acrylate, isoamyl (meth)acrylate, n-hexyl (meth)acrylate, 2-ethylhexyl (meth)acrylate, n-octyl (meth)acrylate, allyl methacrylate, methyl methacrylate, butyl acrylate, butyl methacrylate, ethyl acrylate, lauryl methacrylate, and mixture thereof.

11. An acrylic copolymer comprising:
an acrylic copolymer having from about 15 to about 40 weight percent of a repeating unit having the formula 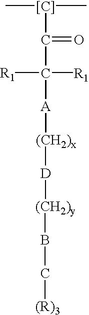
wherein A is 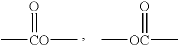
or bond, D and B are each selected from the group consisting of 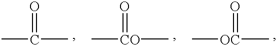
R₁ is a one to four carbon alkyl group, R is hydrogen or the same or a mixture of aliphatic groups having from about 1 to about 26 carbon atoms and which may include one or more ester linkages, x is from 0 to 20 and y is from 0 to 20,
wherein the acrylic copolymer has a hydroxyl number of not more than about 135 to about 40, a number average molecular weight of from about 1,000 to about 3,000, a polydispersity index of not more than about 3, a T_{g} of from about 30° C. to about SOC, a solids content of at least about 80%, an organic solvent content of less than 20 weight percent and a viscosity of not more than about 6,800 cps at about 25° C.

12. The acrylic copolymer as recited in claim 11 wherein the acrylic copolymer is a reaction product of
at least one acrylic monomer having an active hydrogen functional group;
at least one α, β unsaturated monomer having which unsaturated monomer does not have active hydrogen functionality; and
at least one α, β unsaturated monomer which includes an ester side group, the ester side group providing a portion of the repeating unit.

13. A method for making a glycidyl modified acrylic polymer comprising reacting
at least one acrylic monomer having an active hydrogen functional group;
at least one α, β unsaturated monomer having which unsaturated monomer does not have active hydrogen functionality; and
at least one α, β unsaturated ester side group monomer which includes an ester side group, the ester side group being bonded to the α, β double bond of the side group monomer, the ester side group including an aliphatic portion with one or more ester groups, the aliphatic portion extending from the α, β double bond and having a molecular weight in the range of from about 130 to about 500,
the acrylic monomer having the active hydrogen functionality, the monomer without active hydrogen functionality, and the ester side group monomer being polymerized through their double bonds to provide the acrylic copolymer, the acrylic copolymer having a hydroxyl number of from about 40 to about 80, a polydispersity index of not more than about 3, and a Mn in the range of from about 1,000 to about 3,000.

14. The method as recited in claim 16 wherein the ester side group monomer has the general formula general formula, 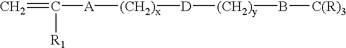
wherein A is 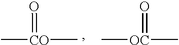
or bond, D and B are each selected from the group consisting of 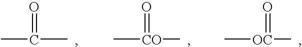
R₁ is a one to four carbon alkyl group, R is hydrogen or the same or a mixture of aliphatic groups having from about 1 to about 26 carbon atoms and which may include one or more ester linkages, x is from 0 to 20 and y is from 0 to 20.

15. An acrylic copolymer which is the reaction product of reactants comprising:
at least one acrylic monomer having an active hydrogen functional group selected from the group consisting of hydroxyl, carboxyl and mixtures thereof;
at least one α, β unsaturated monomer having which unsaturated monomer does not have active hydrogen functionality; and
at least one α, β unsaturated monomer which includes an ester side group, the ester side group being bonded to the α, β double bond of the monomer, the ester side group including an aliphatic group with one or more ester groups,
the acrylic monomer having an active hydrogen functional group comprises from about 1 to about 20 weight percent;
the α, β unsaturated monomer having which unsaturated monomer does not have active hydrogen functionality comprises from about 40 to about 80 weight percent; and
the α, β unsaturated monomer which includes an ester side group comprises from about 15 to about 40 weight percent, the weight percents based upon the weights of the acrylic monomer having an active hydrogen functionality, the non-active hydrogen functional monomer, and ester side group monomer,
the ester side group monomer having the formula 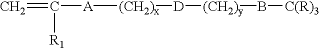
wherein A is 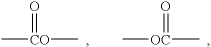
or bond, D and B are each selected from the group consisting of 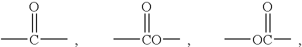
R₁ is a one to four carbon alkyl group, R is hydrogen or the same or a mixture of aliphatic groups having from about 1 to about 26 carbon atoms and which may include one or more ester linkages, x is from 0 to 20 and y is from 0 to 20,
the acrylic monomer having the active hydrogen functionality, the monomer without active hydrogen functionality, and the ester side group monomer being polymerized through their double bonds to provide the acrylic copolymer, the acrylic copolymer having a hydroxyl number of not more than about 135, a polydispersity index of not more than about 3, and a Mn in the range of from about 500 to about 5,000,
a solids content of at least about 80%, an organic solvent content of less than 20 weight percent and a viscosity of not more than about 6,800 cps at about 25° C.

16. The acrylic copolymer as recited in claim 15, wherein the ester side group monomer includes 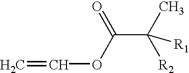
where R₁+R₂=alkyls having a total of 6 carbon atoms.

17. The acrylic copolymer as recited in claim 15, wherein the ester side group monomer includes 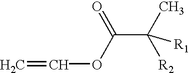
where R₁+R₂=alkyls having a total of 7 carbon atoms.

18. The acrylic copolymer as recited in claim 15, 16, or 17, wherein the active hydrogen functional group is hydroxyl.

19. An acrylic copolymer which is the reaction product of reactants comprising:
from about 23.7 to about 29.0 weight percent acetoacetoxyethyl methacrylate;
from about 0.4 to about 0.7 weight percent methacrylic acid;
from about 7.4 to about 9.1 weight percent hydroxyl ethyl methacrylate;
from about 21.0 to about 25.7 weight percent butyl acrylate;
from about 24.7 to about 30.3 weight percent styrene;
from about 10.3 to about 12.7 weight percent butyl methacrylate; and
from about 2.1 to about 2.6 weight percent methyl methacrylate,
the acrylic copolymer having a solids content of at least about 80%, an organic solvent content of less than 20 weight percent and a viscosity of not more than about 6,800 cps at about 25° C.

20. An acrylic copolymer which is the reaction product of reactants comprising:
from about 33.6 to about 40.0 weight percent of a compound selected from the group consisting of 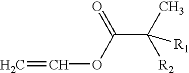
where R₁+R₂=alkyls having a total of 6 carbon atoms, and 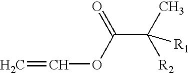
where R₁+R₂=alkyls having a total of 7 carbon atoms;
from about 0.7 to about 0.85 weight percent methacrylic acid;
from about 14.3 to about 17.5 weight percent hydroxyl ethyl methacrylate;
from about 24.0 to about 29.4 weight percent butyl acrylate;
from about 13.5 to about 16.5 weight percent butyl methacrylate; and
from about 3.8 to about 4.7 weight percent methyl methacrylate,
the acrylic copolymer having a solids content of at least about 80%, an organic solvent content of less than 20 weight percent and a viscosity of not more than about 6,800 cps at about 25° C.
